(19) United States
(12) Patent Application Publication
(10) Pub. No.: US 2005/0010674 A1
(43) Pub. Date: Jan. 13, 2005

(54) Content distribution system and content distribution method

(75) Inventors: Kunihiro Taniguchi, Tokyo (JP); Akira Arutaki, Tokyo (JP); Koichi Konishi, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/886,293

(22) Filed: Jul. 7, 2004

(30) Foreign Application Priority Data
Jul. 9, 2003 (JP) 2003-272121

(51) Int. Cl. G06F 15/16; G06F 15/173; H04L 9/00

(52) U.S. Cl. 709/231; 709/219; 713/163

(57) ABSTRACT

To obtain a content distribution system in which the load placed on a distribution server is reduced, the installation cost and the operational cost are reduced, introduction can be easily realized in a large area, and clients only wait short periods for playing back. A distribution server device converts a content into stream data using an algorithm of near video on demand, and transmits the stream data to an end-system multicast tree established among plural client devices requesting playback of the content. The client devices relay the received stream data of the near video on demand in accordance with the end-system multicast tree.

### BACKGROUND OF THE INVENTION

1. Field of the Invention

The present invention relates to a content distribution system and a content distribution method, in which contents are distributed from a distribution server device holding the contents to plural client devices. Further, the present invention relates to a distribution server device, client devices and programs used in a content distribution system.

2. Related Art

In a conventional video-on-demand (VOD) content distribution system, requests from clients concentrate on a content distribution server which distributes contents. In order to cope with all requests, the installation cost for distribution and a distribution bandwidth are required in proportion to the number of users. As the number of users increases, the cost and the distribution bandwidth become enormous. Further, the distribution bandwidth of the distribution server device has a limitation, which causes a problem of not being able to cope with huge requests.

In order to solve this problem, a mirroring method and a cache method are considered. A mirroring method and a cache method use a proxy server called a mirror server or a cache server, within which copies of contents provided on the Internet are stored, whereby the proxy server copes with requests from clients. These methods have such advantages that a proxy server can be introduced easily, and the distribution frequency from the origin server is reduced, so that traffics of the networks near the origin server and the load placed on the server can be balanced.

The mirroring method or the cache method is a method in which the load concentrated on the origin server is balanced, or the link bandwidth near the origin server is reduced. In other words, they do not offer any effect of reducing the distribution bandwidth as a whole. Thus, if the distribution scale is enlarged, the installation cost or the operating cost increases proportionally.

In order to accept requests from clients as much as possible, a content distribution system adopting a near-video-on-demand (NVOD) distribution system is considered. The NVOD distribution system is a stream distribution in accordance with a particular algorithm using broadcasting protocols. In this system, the whole or a part of a content is repeatedly distributed with staggered start times. The broadcasting protocols are disclosed by Steven W. Carter, Darrell D. E. Long, and Jehan-Francois Paris, in Video-on-Demand Broadcasting Protocols, In Multimedia Communications: Directions and Innovations (J. D. Gibson, Ed.), Academic Press, San Diego, 2000, pages 179-189 (document 1).

Near-video-on-demand distribution will be explained with reference to FIGS. 1 and 2. FIG. 1 shows an exemplary schedule of a near-video-on-demand distribution. In FIG. 1, channels are transmission paths for distributing segments periodically, segments are partial data of content which is divided, cycles are periodic times of segments distributed periodically, and distribution reference time is a time on the basis of which cycles start.

Over a channel 1, a segment S1 is repeatedly distributed in all of the cycles 1 to 8. Over a channel 2, a segment S2 is repeatedly distributed in the odd cycles 1, 3, 5 and 7, and a segment S4 or S5 is repeatedly distributed in the even cycles 2, 4, 6 and 8. Over a channel 3, plural segments S3, S6, S7, S8 and S9 are allocated to plural cycles 1 to 8, respectively, and distributed according to an algorithm.

Such information of a distribution schedule calculated in accordance with a particular algorithm using broadcasting protocols is a distribution schedule of a near video on demand.

FIG. 2 shows another exemplary distribution schedule of near video on demand. The distribution schedule shown in FIG. 2 is one which is calculated according to an algorithm using pyramid broadcasting protocols. With this algorithm, a content is so divided that a following segment has a longer playing back time period than the precedent segment, and one segment is repeatedly distributed over one channel. Further, the distribution rate of each channel must be equal to a times of the playback rate (α≧1). In the example shown in FIG. 2, α=2. Since the length of each segment S1, S2 or S3 differs in FIG. 2, each segment S1, S2 or S3 is repeatedly transmitted with a different cycle for each channel 1, 2 or 3.

In the near-video-on-demand distribution system, a distribution server device carries out a stream distribution in accordance with a prescribed distribution schedule, and carries out multicast distribution responding to requests arrived within a certain time period. The multicast distribution in the NVOD distribution system typically uses IP multicast. This method provides such an advantage for clients that contents can be played back at any time with only a short waiting period. It also provides an advantage for a distribution server device that distribution can be done in a certain distribution bandwidth without depending on the number of clients.

However, in order to carrying out multicast distribution in the NVOD distribution system, an IP multicast network must be established. In order to realize IP multicast distribution, a network including routers corresponding to the IP multicast is required, and also the installation cost for routers corresponding to the IP multicast is required. Further, there is a disadvantage that it is quite difficult to introduce on the Internet where the IP multicast is not supported.

On the other hand, there is end-system multicast as a multicast distribution system. In the end-system multicast, multicast is so realized that a distribution tree is established among clients requesting the distribution. The methods of establishing an end-system multicast tree include a concentration type and a dispersion type. An example of the concentration type is described by D. Pendarakis, Sherlia Shi, D. Verma and M. Waldvogel, in “ALMI: An Application Level Multicast Infrastructure”, in Proc., USITS, March, 2001 (document 2). In this method, a concentration server called a session controller performs tree calculations and distribution of the calculation result.

An example of the dispersion type is described by Y. Chu, S. G. Rao and H. Zhang, in “A Case for End System Multicast”, in Proc., ACM SIGMETRICS 2000, June, 2000 (document 3). In this method, clients obtain information about several tree participation nodes from a server called a rendezvous point. Clients connect to one of them, and notify other clients of node information held by them. In this way, clients exchange node information with one another, to thereby exchange tree information.

The system disclosed in the document 3 realizes multicast distribution through establishing a distribution tree on an upper layer than the IP layer. Thereby, it provides an advantage that the multicast can be easily introduced for a large area. Further, it also provides an advantage of not causing cost for managing the installation since the multicast network is established by clients, requesting the distribution, serving as relay nodes.

However, this method has a disadvantage as a distribution system using an end-system multicast tree. Although this system is suitable for live distribution in which distribution starts at a predetermined time, it is not suitable for VOD distribution in which distribution starts at a time that a client requests.

As described above, the VOD content distribution system requires a larger distribution bandwidth since a distribution bandwidth is allocated for each client.

Further, the mirroring method and the cache method require installation and management corresponding to the distribution scale, whereby the installation cost and operational cost increase.

On the other hand, in the NVOD distribution system, although it is expected to use IP multicast, it is difficult to be introduced on an IP network where the IP multicast is not supported. In order to support the IP multicast, routers corresponding to the IP multicast must be deployed, which requires a high installation cost. Moreover, the cost for managing and operating the routers increases.

Further, in the case of end-system multicast, the same content is distributed to all clients almost at the same time, which is difficult to start playing back with a short waiting time period or to start playing back responsive to a playback request from a client.

As described above, there has been no content distribution system conventionally which reduces the load placed on the distribution server device, which lowers installation and operational costs, which is easily introduced in a wide area, and which provides short waiting time periods for clients.

An object of the present invention is to provide a content distribution system, a distribution server device, client devices, a content distribution method, and programs, in which the distribution bandwidth of the distribution server device is small.

Another object of the present invention is to provide a content distribution system, a distribution server device, client devices, a content distribution method, and programs, in which clients only wait for short time periods for playing back.

Another object of the present invention is to provide a content distribution system, a distribution server device, client devices, a content distribution method, and programs, which do not depend on distribution scales and require less installation cost and operational cost.

Another object of the present invention is to provide a content distribution system, a distribution server device, client devices, a content distribution method, and programs, which can be introduced easily.

In order to achieve the aforementioned objects, a content distribution method includes, as the basic structure, a distribution server device which holds a content and distributes the content corresponding to requests, and a plurality of client devices which request the distribution server device to play back the content, and comprises the steps of: transmitting stream data, obtained by converting the content in accordance with an algorithm of near video on demand, from the distribution server device to the client devices in accordance with a multicast tree composed of the plurality of client devices; and relaying the stream data received by the client devices to other client devices in accordance with the multicast tree to thereby transmit the stream data.

Further, a content distribution system for carrying out the aforementioned content distribution method according to the present invention causes to perform functions of transmitting stream data obtained by converting the content in accordance with an algorithm of near video on demand to a multicast tree composed of the plurality of client devices, and relaying the stream data received from the distribution server device to other client devices in accordance with the multicast tree to thereby transmit the stream data.

Further, a program for causing the content distribution method of the present invention to be executed by the content distribution system includes, a transmitting function for causing the distribution server device to execute a function of transmitting stream data, obtained by converting the content in accordance with an algorithm of near video on demand, in accordance with a multicast tree composed of the plurality of client devices; and a relaying function for causing the client devices which receive the stream data to execute a function of relaying the stream data to other client devices in accordance with the multicast tree to thereby transmit the stream data.

As described above, the distribution server device according to the present invention converts a content into stream data in accordance with an algorithm of near video on demand, and transmits the stream data to a multicast tree consisting of client devices requesting playback of the content. Further, the client devices relay the received stream data of the near video on demand in accordance with the multicast tree.

### EFFECTS OF THE INVENTION

A first effect of the present invention is to reduce the load placed on the distribution server device. This is because the stream data is distributed to all client devices using the multicast tree consisting of the plural client devices even when requests from the plural client devices are concentrated on the distribution server.

A second effect of the present invention is to suppress waiting periods of clients for playback to be short. This is because the stream data converted using an algorithm of the near video on demand can take timings to start playing back in short cycles.

A third effect of the present invention is to reduce the installation cost and the operational costs of the content distribution system. This is because any specific installation for establishing multicast distribution network is not required since distribution is performed by establishing multicast tree among plural client devices requesting distribution. At the same time, the burden of managing the installation is reduced. Further, there is no need to deploy mirror servers or cache servers corresponding to the distribution scale, whereby the cost required for such an installation can be saved, and the burden of managing the installation is also reduced.

A forth effect of the present invention is that near video on demand can be easily introduced. This is because the multicast network is established on an upper layer than the IP layer, which enables near video on demand distribution to be realized on an IP network in which IP multicast is not supported.

### BRIEF DESCRIPTION OF THE DRAWINGS

FIG. 1 is a chart showing an example of a distribution schedule of near video on demand (NVOD);

FIG. 2 is a chart showing another example of a distribution schedule of NVOD;

FIG. 3 is a diagram showing the structure of a content distribution system according to a first embodiment of the present invention;

FIG. 4A is a flowchart showing the operation of the distribution server device in FIG. 3;

FIG. 4B is a flowchart showing the operation of the client device in FIG. 3;

FIG. 5 is a diagram showing the structure of a content distribution system according to a second embodiment of the present invention;

FIG. 6A is a flowchart showing the operation of the distribution server device in FIG. 5;

FIG. 6B is a flowchart showing the operation of the client device in FIG. 5;

FIG. 7 is a diagram showing the structure of a content distribution system according to a third embodiment of the present invention;

FIG. 8A is a flowchart showing the operation of the distribution server device in FIG. 7;

FIG. 8B is a flowchart showing the operation of the client device in FIG. 7;

FIG. 9 is a chart showing tree selected using a transformation (1) when a content is distributed in accordance with the distribution schedule in FIG. 1;

FIG. 10 is a chart showing tree selected using a transformation (2) when a content is distributed in accordance with the distribution schedule in FIG. 1; and

FIG. 11 is a chart showing tree selected using a transformation (3) when a content is distributed in accordance with the distribution schedule in FIG. 1.

### PREFERRED EMBODIMENTS OF THE INVENTION

Embodiments of the present invention will be described below with reference to the drawings.

Each embodiment of the present invention describes an example of distributing contents by near video on demand (NVOD) on end-system multicast tree consisting of client devices which request to play back the contents in a distribution system of distributing such as motion pictures and voices. However, contents distributed are not limited to motion pictures or voices, but also applicable to general data in the same way. Similar elements are denoted by the same reference numerals in the drawings described below.

### Embodiment 1

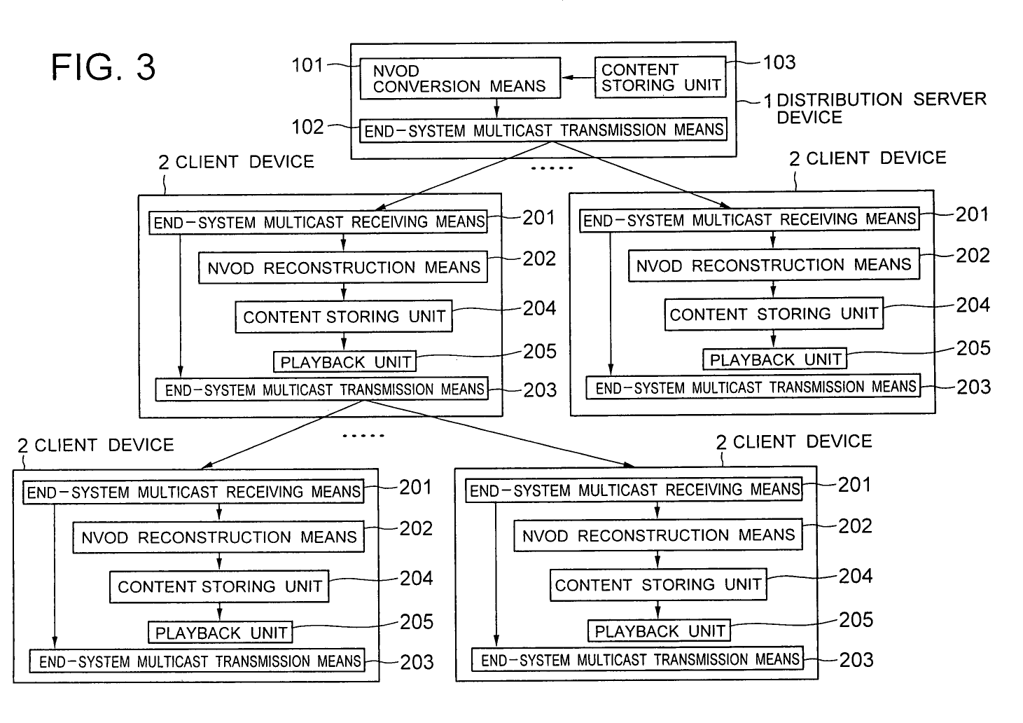

In FIG. 3, a content distribution system according to a first embodiment of the present invention comprises a distribution server device 1 such as a server computer and client devices 2 such as personal computers.

The distribution server device 1 includes a near-video-on-demand (NVOD) conversion means 101, an end-system multicast transmission means 102, and a content storing unit 103 which stores contents to be distributed.

The NVOD conversion means 101 reads out a content from the content storing unit 103 and converts it into stream data in accordance with an algorithm of the NVOD.

The end-system multicast transmission means 102 establishes at least one end-system multicast tree among plural client devices which request to play back the content, and transmits stream data converted by the NVOD conversion means 101.

The client device 2 includes an end-system multicast receiving means 201, a near-video-on-demand (NVOD) reconstruction means 202, an end-system multicast transmission means 203, a content storing unit 204, and a playback unit 205.

The end-system multicast receiving means 201 receives stream data transmitted by the end-system multicast transmission means 102. The NVOD reconstruction means 202 reconstructs the stream data received by the end-system multicast receiving means 201 to the original content, which is the content before converted.

The end-system multicast transmission means 203 relays the stream data received by the end-system multicast receiving means 201 in accordance with the end-system multicast tree, and transmits the data to another client devices 2 requesting playback. The content storing unit 204 stores the reconstructed content, and the playback unit 205 plays back the content.

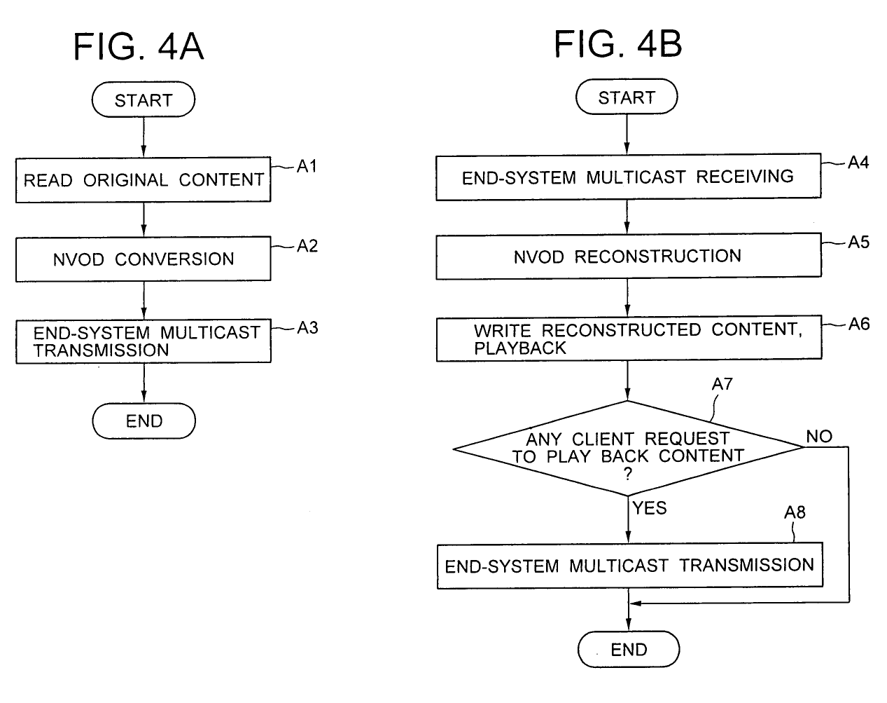

Next, the operation of the content distribution system according to the first embodiment of the present invention will be described with reference to the drawings. The operation of the distribution server device shown in FIG. 3 is shown in FIG. 4A, and the operation of the client devices shown in FIG. 3 is shown in FIG. 4B.

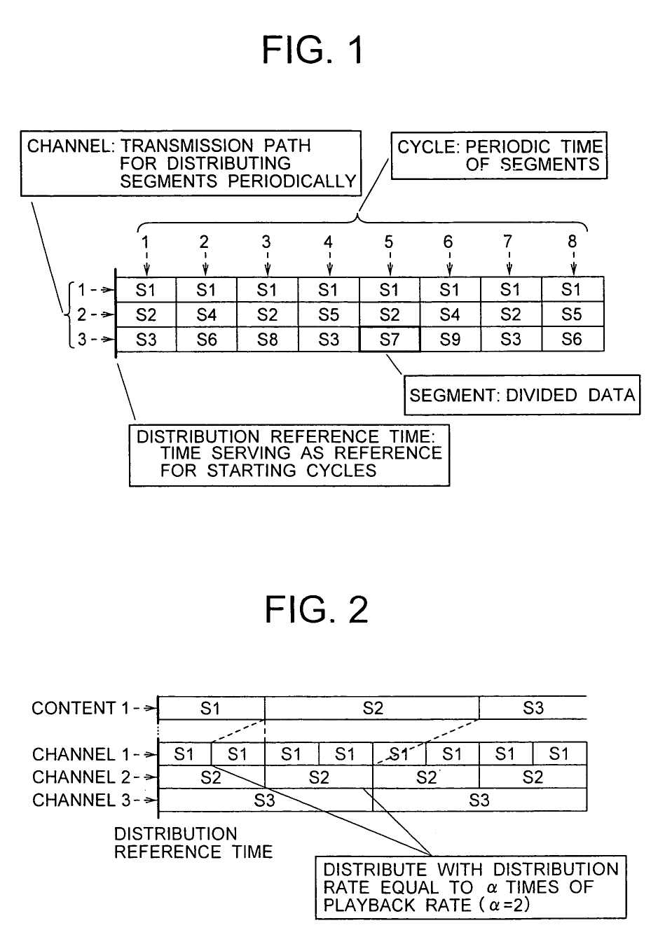

First, the operation of the distribution server device 1 will be explained. The distribution server device 1 is assumed to have hold a near-video-on-demand (NVOD) distribution schedule like one shown in FIG. 1 or FIG. 2 beforehand.

In FIG. 4A, the content storing unit 103 reads out the original content when the distribution reference time comes, and supplies the information to the NVOD conversion means 101 (step A1).

The NVOD conversion means 101 converts the content supplied from the content storing unit 103 into stream data in accordance with an algorithm of the NVOD, and output it (step A2). In other words, the NVOD conversion means 101 divides the content into plural segments as shown in FIGS. 1 and 2, and outputs the divided contents repeatedly using plural channels.

The end-system multicast transmission means 102 establishes an end-system multicast tree among the client devices 2 so as to distribute the content to the client devices 2 requesting playback of the content. Then, the end-system multicast transmission means 102 transmits the stream data from the NVOD conversion means 101 to the end-system multicast tree (step A3 in FIG. 2). If, during the transmission of the stream data, client devices not constituting the end-system multicast tree request the distribution server device 1 to play back the content, the end-system multicast transmission means 102 reconstitutes the tree in order to incorporate the client devices therein, and transmits the stream data to the reconstituted tree.

Next, the operation of the client device 2 will be described. Each client device 2 is assumed to have made a playback request to the distribution server device 1, and have obtained distribution schedule information necessary for the NVOD distribution and have obtained distribution tree information necessary for establishing the end-system multicast tree. Methods of calculating and providing the information may be realized by combining the concentration type and the diversion type described above in any way.

In FIG. 4B, the end-system multicast receiving means 201 participates in the end-system multicast tree and receives stream data of plural channels (step A4). The end-system multicast receiving means 201 also supplies the received stream data to the NVOD reconstruction means 202. The NVOD reconstruction means 202 reconstructs the stream data supplied from the end-system multicast receiving means 201 into the original content which is the content before NVOD converted (step A5), and supplies the reconstructed content to the content storing unit 204. The content storing unit 204 stores the content supplied from the NVOD reconstruction means 202. The playback unit 205 plays back the content read out from the content storing unit 204 (step A6).

The end-system multicast transmission means 203 relays the stream data received in accordance with the end system multicast tree. That is, if there are other client devices 2 for which relaying is required (Yes in the step A7), the end-system multicast transmission means 203 transmits the stream data to these client devices 2 (step A8).

As described above, in the first embodiment of the present invention, the streaming distribution is carried out with end-system multicast. Thereby, the distribution server device 1 is not required to allocate a distribution band for each client device. Consequently, the load placed on the distribution server device 1 can be reduced.

Further, since the streaming distribution is performed while being controlled according to an algorithm of the NVOD, it is possible to set timings to start playback in short cycles. Therefore, the client devices 2 can start playing back with short waiting periods.

Further, since the distribution is performed in such a manner that the multicast network is established among the client devices 2, any specific installation such as a mirror server or a cache server depending on the distribution scale or routers corresponding to IP multicast for building a multicast distribution network is not required, whereby the burden of managing the installation can be also reduced. Consequently, the installation cost and the operational cost can be lowered.

Further, since the present embodiment uses end-system multicast instead of using IP multicast, a multicast network can be established on a upper layer than the IP layer, whereby it can be easily introduced into the IP network.

Processing operations of the distribution server device 1 and the client devices 2 in accordance with each flowchart shown in FIGS. 4A and 4B can be realized with the following configuration. That is, programs for content distribution based on the flowcharts shown in FIGS. 4A and 4B are made to have been stored in storage media such as ROMs incorporated in computers consisting the distribution server device 1 and the client devices 2. Then, the CPU of each computer reads out the program and executes the program, whereby the processing operations of the distribution server 1 and the client devices 2 are realized in accordance with the flowcharts shown in FIGS. 4A and 4B.

### Embodiment 2

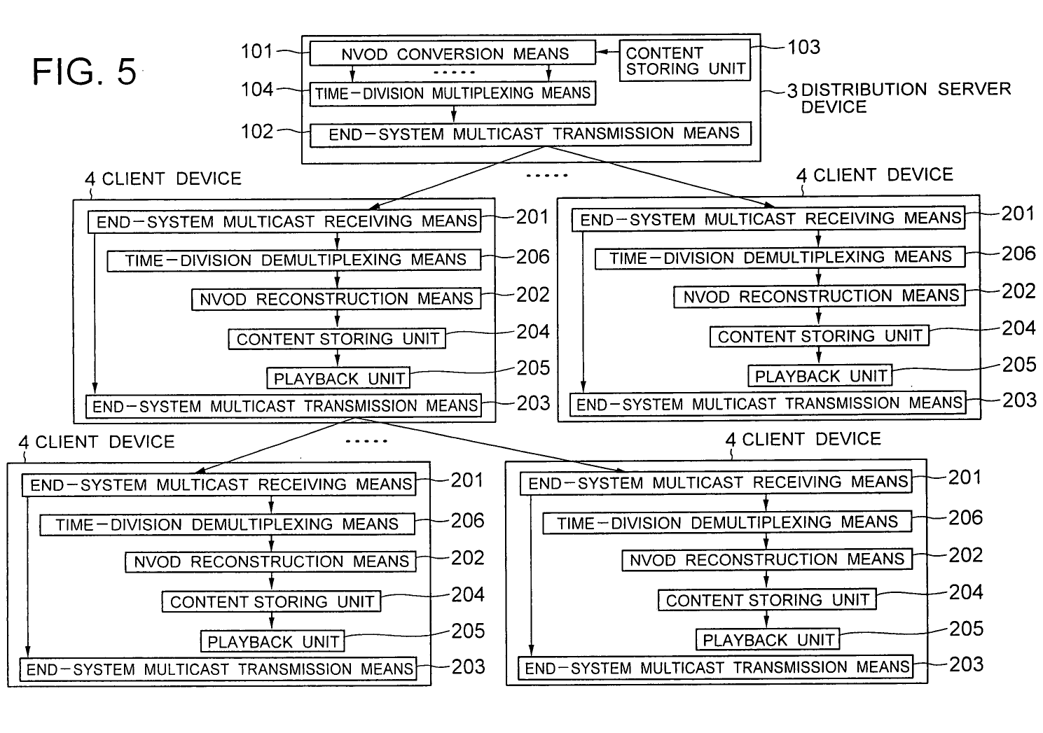

FIG. 5 is a diagram showing the structure of a content distribution system according to a second embodiment of the present invention. Referring to FIG. 5, the content distribution system according to the second embodiment of the present invention comprises a distribution server device 3 such as a server computer and client devices 4 such as personal computers.

The distribution server device 3 according to the second embodiment of the present invention includes, in addition to the structure of the distribution server device 1 shown in FIG. 3, a time-division multiplexing means 104. The client device 4 includes, in addition to the structure of the client device 2 shown in FIG. 3, a time-division demultiplexing means 206.

The time-division multiplexing means 104 of the distribution server 3 time-division multiplexes plural channels from the NVOD conversion means 101, and supplies the information of the channel which are time-division multiplexed to the end-system multicast transmission means 102.

The time-division demultiplexing means 206 of the client device 4 separates the time-division multiplexed channel received from the end-system multicast receiving means 201 into the original plural channels, and supplies information about the separated, plural channels to the NVOD reconstruction means 202.

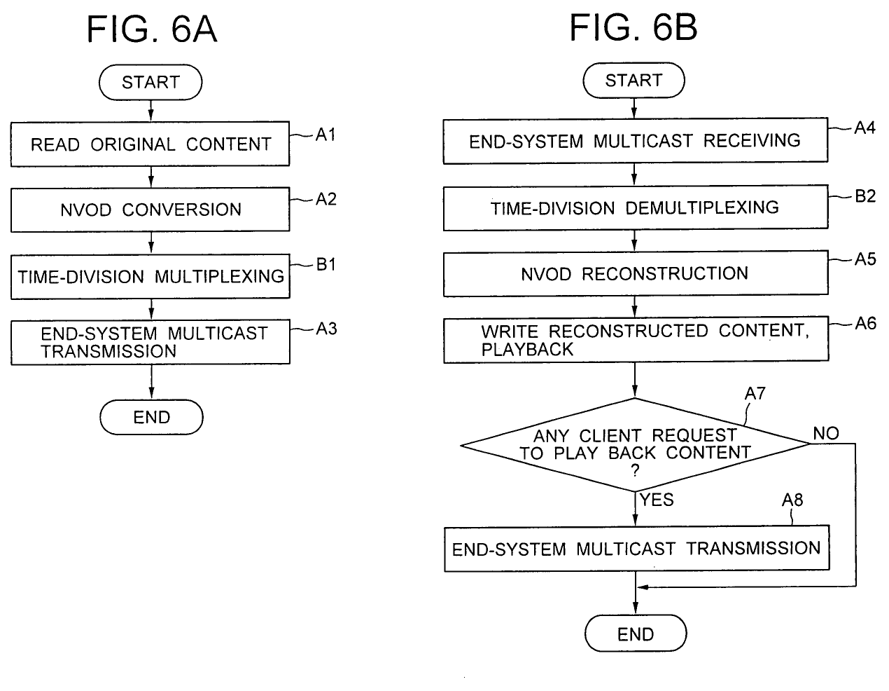

Next, the operation of the content distribution system according to the second embodiment of the present invention will be described with reference to the drawings. The operation of the distribution server device 3 shown in FIG. 5 is shown in FIG. 6A. The operation of the client device 4 shown in FIG. 5 is shown in FIG. 6B.

First, the operation of the distribution server device 3 will be explained. The distribution server device 3 is assumed to have held the distribution schedule information of the NVOD like one shown in FIGS. 1 and 2. Steps Al and A2 in FIG. 6A are same as that of the first embodiment.

Based on the information about plural channels supplied from the NVOD conversion means 101, the time-division multiplexing means 104 time-division-multiplexes the plural channels (step B1).

The end-system multicast transmission means 102 establishes an end-system multicast tree among the client devices 4 so as to distribute the content to the client devices 4 requesting playback of the content. Then, the end-system multicast transmission means 102 transmits segments (divided contents) to the end-system multicast tree through the time-division-multiplexed channel output from the time-division multiplexing means 104 (step A3).

Next, the operation of the client device 4 will be described. Each client device 4 is assumed to have requested the distribution server device 3 to play back the content, and have obtained distribution schedule information required for the NVOD distribution and have obtained distribution tree information required for establishing the end-system multicast tree.

In FIG. 6B, the end-system multicast receiving means 201 participates in the end-system multicast tree, and receives data of the time-division multiplexed channel supplied from the end-system multicast transmission means 102. Further, the end-system multicast transmission means 201 supplies the received, time-division multiplexed channel data to the time-division demultiplexing means 206 (step A4).

The time-division demultiplexing means 206, based on the time-division multiplexed channel data supplied from the end-system multicast receiving means 201, demultiplexes and separates the channel into the original plural channels (step B2). Then, processing of the steps A5 and A6 are carried out as same as the case of the first embodiment.

The end-system multicast transmission means 203 relays the time-division multiplexed channel data received in accordance with the end-system multicast tree. That is, in a case where other client devices 4 requiring relays exist (YES in the step A7), the end-system multicast transmission means 203 transmits the time-division multiplexed channel data received by itself to the client devices 4 (step A8).

In the second embodiment of the present invention, in addition to the aforementioned effects of the first embodiment, the segments (divided contents) are to be transmitted over the time-division multiplexed channel, whereby gaps in synchronization between channels due to delays in the network or in the stream data relay can be prevented, and starvation of playback buffer can be suppressed, when the contents are reconstructed.

The processing operations of the distribution server device 3 and the client devices 4 according to respective flowcharts shown in FIGS. 6A and 6B can be realized by the following structures. Programs for content distribution based on the flowcharts shown in FIGS. 6A and 6B have been stored in storing media such as ROMs incorporated in computers constituting the distribution server device 3 and the client devices 4. Then, the programs are read by the CPU of the computer, and are executed, whereby the processing operations of the distribution server 3 and the client devices 4 in accordance with the flowcharts shown in FIGS. 6A and 6B can be realized.

### Embodiment 3

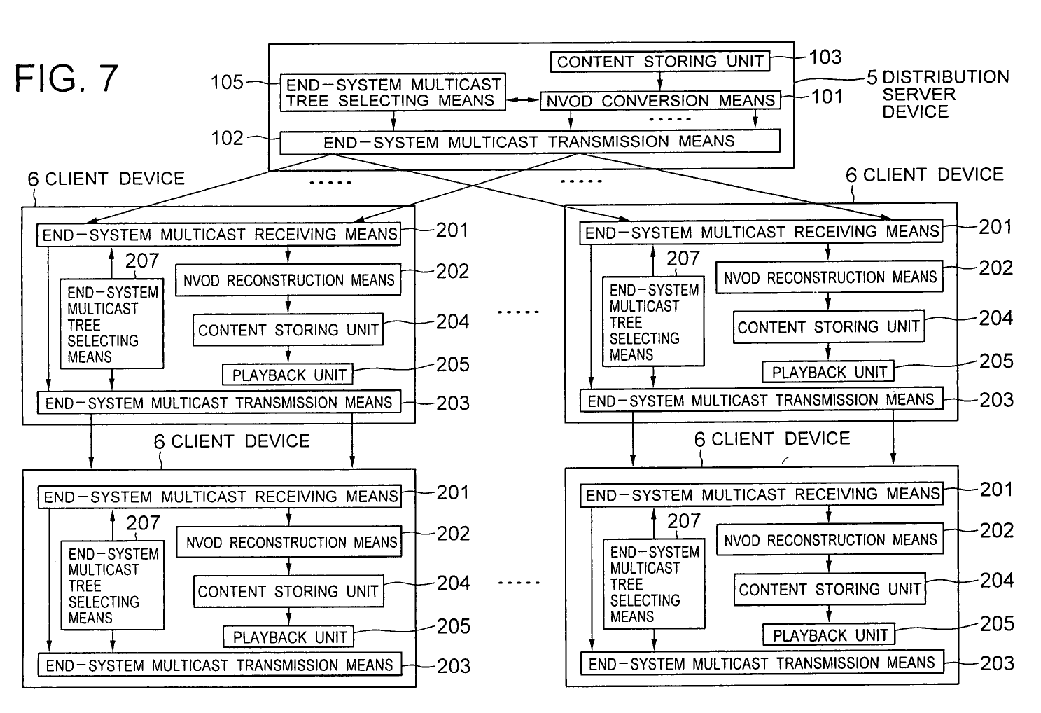

FIG. 7 is a diagram showing the structure of a content distribution system according to a third embodiment of the present invention. Referring to FIG. 7, the content distribution system according to the third embodiment of the present invention comprises a distribution server device 5 such as a server computer, and client devices 6 such as personal computers.

The distribution server device 5 according to the third embodiment of the present invention includes, in addition to the structure of the distribution server device shown in FIG. 3, an end-system multicast tree selecting means 105. The client terminal 6 includes, in addition to the structure of the client terminal 2 shown in FIG. 3, an end-system multicast tree selecting means 207.

The end-system multicast tree selecting means 105 selects which end-system multicast tree is used to transmit the stream data output from the NVOD conversion means 101. Then, the end-system multicast tree selecting means 105 outputs to the end-system multicast transmission means 102 an instruction to transmit the stream data using the selected end-system multicast tree. Based on the instruction from the end-system multicast tree selecting means 105, the end-system multicast transmission means 102 transmits the stream data through the selected end system multicast tree.

The end-system multicast tree selecting means 207 selects that from which end-system multicast tree it receives the stream data transmitted from the end system multicast transmissions means 102. Then, the end-system multicast tree selecting means 207 outputs to the end-system multicast receiving means 201 an instruction to receive the stream data from the end-system multicast tree selected by the end-system multicast tree selecting means 105. The end-system multicast receiving means 201 receives the stream data according to the instruction of the end-system multicast tree selecting means 105.

Further, the end-system multicast tree selecting means 207 outputs to the end-system multicast transmission means 203 an instruction to transmit the stream data using the end-system multicast tree selected by the end-system multicast tree selecting means 105. According to the instruction of the end-system multicast tree selecting means 105, the end-system multicast transmission means 203 transmits to other client devices 6 the stream data received by the end-system multicast receiving means 201.

The third embodiment of the present invention has such a feature that, with a function of selecting an end-system multicast tree performed by the end-system multicast tree selecting means, a different end-system multicast tree is allocated to each channel, whereby stream data is transmitted and received over plural channels.

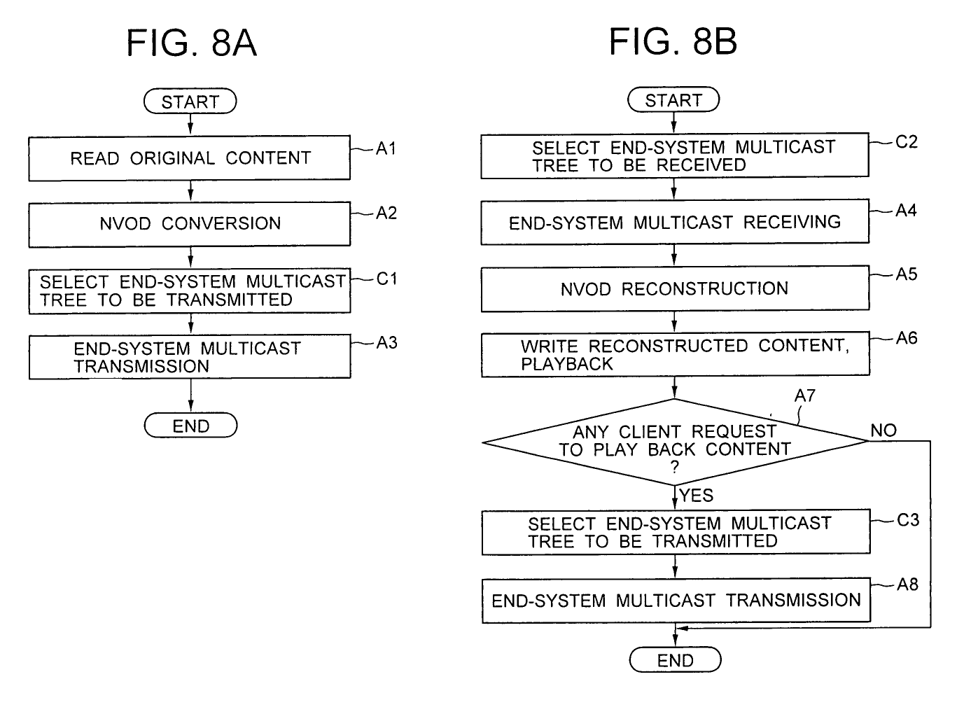

Next, the operation of the content distribution system according to the third embodiment of the present invention will be described with reference to the drawings. The operation of the distribution server device 5 shown in FIG. 7 is shown in FIG. 8A, and the operation of the client device 6 shown in FIG. 7 is shown in FIG. 8B.

First, the operation of the distribution server device 5 will be described. The distribution server device 5 is assumed to have held NVOD distribution schedule information like ones shown in FIGS. 1 and 2. The steps A1 and A2 shown in FIG. 8A are same as that of the first embodiment.

The end-system multicast transmission means 102 performs distribution of stream data using an end-system multicast tree allocated for each channel. Thus, the end-system multicast tree selecting means 105 selects which end-system multicast tree is used for transmission over each channel (step C1).

Here, the end-system multicast tree selecting means 105 selects an end-system multicast tree for each channel using the following transformation (1):
tree_ID=channel_ID (1)

Note that tree_ID indicates an end-system multicast tree identifier (tree number), and channel_ID indicates a channel identifier (channel number).

FIG. 9 is a chart showing a tree selected using the transformation (1) in a case of distributing a content in accordance with the distribution schedule shown in FIG. 1. As shown in FIG. 9, if a content is distributed according to the distribution schedule shown in FIG. 1, the end-system multicast tree selecting means 105 performs setting in the following manner: that is, a channel with a channel number “1” (channel 1) participates in an end-system multicast tree with a tree number “1” (end-system multicast tree 1), a channel with a channel number “2” (channel 2) participates in an end-system multicast tree with a tree number “2” (end-system multicast tree 2), and a channel with a channel number “3” (channel 3) participates in an end-system multicast tree with a tree number “3” (end-system multicast tree 3), respectively, to thereby transmit the content. Then, the end-system multicast tree selecting means 105 outputs to the end-system multicast transmission means 102 an instruction based on the aforementioned setting.

According to the selection of the end-system multicast tree selecting means 105, the end-system multicast transmission means 102 establishes an end-system multicast tree for each channel among client devices 4 requesting playback of the content. Then, the end-system multicast transmission means 102 transmits the segments (divided contents) over plural channels to the selected, corresponding end-system multicast trees (step A3 in FIG. 8A).

Next, the operation of the client device 6 will be described. Each of the client device 6 is assumed to have requested the distribution server device 5 to play back the content and have obtained the distribution schedule information required for the NVOD distribution and have obtained the distribution tree information required to establish end-system multicast trees.

In FIG. 8B, the end-system multicast tree selecting means 207 selects that, using the transformation (1), from which end-system multicast tree it receives each segment required for playing back the content, and performs setting of the end-system multicast receiving means 201 (step C2 in FIG. 8A).

If the content is distributed in accordance with the distribution schedule shown in FIG. 1, the end-system multicast tree selecting means 207 performs setting in such a manner that in a cycle 1 (a cycle with a cycle number “1”), the end-system multicast receiving means 201 is set to participate in end-system multicast trees 1 to 3 so as to receive segments 1 to 3 (segments with segment numbers “1” to “3”), and in a cycle 2, it is set to participate in end-system multicast trees 2 and 3 so as to receive segments 4 and 6. In the cycle 2, since it is not required to receive the segment 1 which has already been received in the cycle 1, the end-system multicast receiving means 201 is set not to participate in the end-system multicast tree 1. Then, the end-system multicast tree selecting means 207 output this setting information to the end-system multicast receiving means 201.

The end-system multicast receiving means 201 participates in the end-system multicast trees in accordance with the selection of the end-system multicast tree selecting means 207, and receives only segments required for playing back the content (step A4 in FIG. 8B). Then, as same as the first embodiment, processing of the steps A5 and A6 in FIG. 8B is performed.

Although the end-system multicast tree selecting means 207 selects the end-system multicast trees in order to only receive segments required for playing back the content, it may perform setting in such a manner that the end-system multicast receiving means 201 participates in all of the end-system multicast trees 1 to 3 in each cycle.

Further, the end-system multicast transmission means 203 relays stream data in accordance with each end-system multicast tree in which the end-system multicast receiving means 201 participates. That is, if there are client devices requesting playback of a content which requires to be relayed to each end-system multicast tree (YES in the step A7 in FIG. 8B), the end-system multicast tree selecting means 207 selects, in accordance with the transformation (1), which end-system multicast tree is used to transmit the segment of each channel received by the end-system multicast receiving means 201, and performs setting of the end-system multicast transmission means 203 (step C3 in FIG. 8B).

In accordance with the selection of the end-system multicast tree selecting means 207, the end-system multicast transmission means 203 transmits the received segment of each channel (step A8 in FIG. 8B).

The third embodiment of the present invention is so configured to establish an end-system multicast tree by a channel unit to thereby perform distribution. Therefore, in addition to the effects of the first embodiment, the client devices 6 can receive only segments required for playing back by selecting a tree to participate in each cycle. Accordingly, it is possible to avoid unnecessary data relay and to reduce the relay bandwidth of the client devices 6.

Processing operations of the distribution server device 5 and the client device 6 according to respective flowcharts shown in FIGS. 8A and 8B can be realized with the following structures. That is, programs for content distribution based on the flowcharts shown in FIGS. 8A and 8B have been stored beforehand in recording media such as ROMs incorporated in computers constituting the distribution server device 5 and the client devices 6. Then, the CPUs of the computers read out and execute the programs, whereby the processing operations of the distribution server device 5 and the client devices 6 can be realized in accordance with the flowcharts shown in FIG. 8A and 8B.

### Embodiment 4

The structure of a content distribution system according to a forth embodiment of the present invention is same as that of the third embodiment, except that the operations of the end-system multicast tree selecting means 105 and 207 are different. The forth embodiment of the present invention will be described with reference to FIGS. 8A and 8B.

The forth embodiment of the present invention has a feature that with a function of selecting end-system multicast trees by the end-system multicast tree selecting means, a different end-system multicast tree is allocated for each segment to thereby transmit and receive stream data over plural channels.

In the forth embodiment of the present invention, the end-system multicast transmission means 102 performs distribution of stream data using an end-system multicast tree allocated for each segment. For this reason, the end-system multicast tree selecting means 105 selects that which end-system multicast tree is used for transmitting each segment (step C1 in FIG. 8A).

Here, the end-system multicast tree selecting means 105 uses the following transformation (2) to thereby select an end-system multicast tree for each segment:
tree_ID=segment_ID (2)

Note that tree_Id indicates an end-system multicast tree identifier (tree number), and segment_ID indicates a segment identifier (segment number).

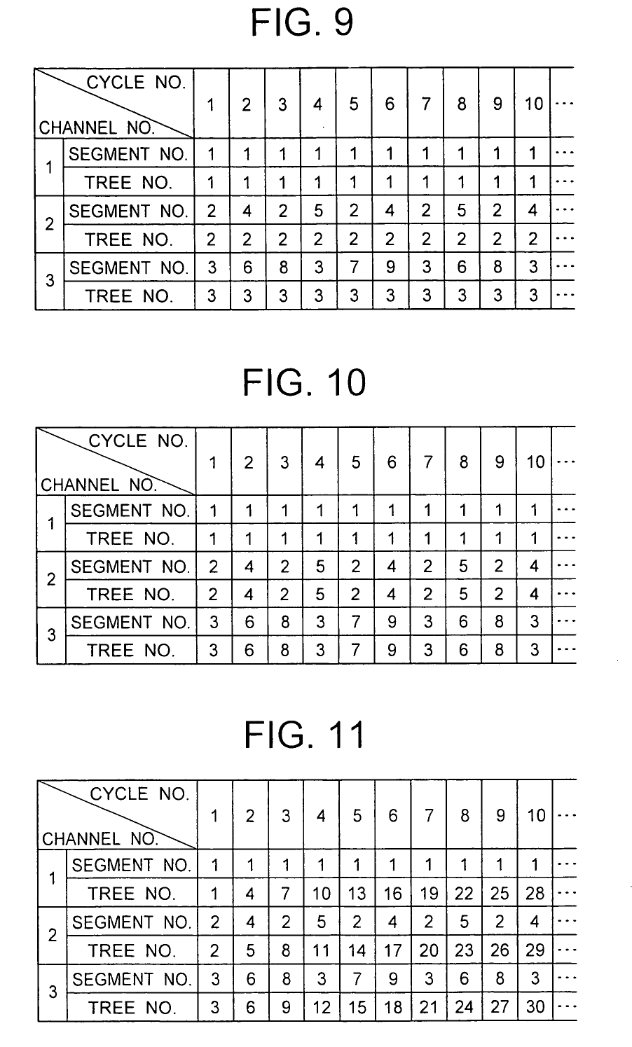

FIG. 10 is a chart showing trees selected using the transformation (2) when a content is distributed in accordance with the distribution schedule shown in FIG. 1. As shown in FIG. 10, in the case of distributing a content according to the distribution schedule in FIG. 1, the end-system multicast tree selecting means 105 performs setting of the end-system multicast transmission means 102 in such a manner as to transmit each segment by participating in an end-system multicast tree having the same tree number as the segment number.

The end-system multicast transmission means 102 establishes, according to the selection of the end-system multicast tree selecting means 105, an end-system multicast tree for each segment among client devices 6 requesting playback of the content, and transmits each segment to a corresponding end-system multicast tree, respectively.

On the other hand, in the client device 6, the end-system multicast tree selecting means 207 selects that from which end-system multicast tree it receives each segment required for playing back the content, using the transformation (2), and according to the selection, it performs setting of the end-system multicast receiving means 201 (step C2 of FIG. 8B).

If the content is distributed in accordance with the distribution schedule in FIG. 1, for example, the end-system multicast tree selecting means 207 performs setting in such a manner that in a cycle 1, the end-system multicast receiving means 201 is set to participate in end-system multicast trees 1 to 3 so as to receive segments 1 to 3, and in a cycle 2, it is set to participate in end-system multicast trees 2 and 3 so as to receive segments 4 and 6. In the cycle 2, since it is not required to receive the segment 1 which has already been received in the cycle 1, the end-system multicast receiving means 201 is set not to participate in the end-system multicast tree 1.

The end-system multicast receiving means 201 participates in the end-system multicast trees in accordance with the selection of the end-system multicast tree selecting means 207, and receives only segments required for playing back the content (step A4 in FIG. 8B).

If there are client devices requesting playback of a content which requires to be relayed to each end-system multicast tree in which the end-system multicast receiving means participate (step A7 in FIG. 8B), the end-system multicast tree selecting means 207 selects, in accordance with the transformation (2), which end-system multicast tree is used to transmit a segment received by the end-system multicast receiving means 201, and in accordance with the selection, performs setting of the end-system multicast transmission means 203 (step C3 in FIG. 8B).

In accordance with the selection of the end-system multicast tree selecting means 207, the end-system multicast transmission means 203 transmits the received segment (step A8 in FIG. 8B).

The forth embodiment of the present invention is so configured to establish an end-system multicast tree by a segment unit and performs distribution. Therefore, in addition to the effects of the first embodiment, the client devices 6 can receive only segments required for playing back by selecting a tree to participate in each cycle, as same as the case of the third embodiment. Accordingly, it is possible to avoid unnecessary data relay and to reduce the relay bandwidth of the client devices 6.

### Embodiment 5

The structure of a content distribution system according to a fifth embodiment of the present invention is same as that of the third embodiment, except that the operations of the end-system multicast tree selecting means 105 and 207 are different. The fifth embodiment of the present invention will be described with reference to FIGS. 8A and 8B.

The fifth embodiment of the present invention has a feature that with a function of selecting end-system multicast trees by the end-system multicast tree selecting means 105, a different end-system multicast tree is allocated for each channel and further a different end-system multicast tree is allocated for each cycle, to thereby transmit and receive stream data over plural channels.

In the fifth embodiment of the present invention, the end-system multicast transmission means 102 distributes stream data using an end-system multicast tree allocated for each channel and for each cycle. For this reason, the end-system multicast tree selecting means 105 selects that which end-system multicast tree is used for transmitting the stream data for each channel in each cycle (step C1 in FIG. 8A).

Here, the end-system multicast tree selecting means 105 uses the following transformation (3) to thereby select an end-system multicast tree for each channel and for each cycle:
tree_ID=(cycle_ID−1)*N_channel+channel_ID (3)

Note that tree_Id indicates an end-system multicast tree identifier (tree number), cycle_ID indicates a cycle identifier (cycle number), channel_ID indicates a channel identifier (channel number), and N_channel indicates the number of channels.

FIG. 11 is a chart showing trees selected using the transformation (3) when a content is distributed in accordance with the distribution schedule shown in FIG. 1. As shown in FIG. 11, in a case of distributing a content according to the distribution schedule in FIG. 1, the end-system multicast tree selecting means 105 performs setting of the end-system multicast transmission means 102 in such a manner as to transmit over plural channels by participating in a different end-system multicast tree for each channel and for each cycle.

The end-system multicast transmission means 102 establishes, according to the selection of the end-system multicast tree selecting means 105, an end-system multicast tree for each segment and for each cycle among client devices 6 requesting playback of the content, and transmits segments (divided contents) over plural channels to a corresponding end-system multicast tree for each cycle (step A3 in FIG. 8A).

On the other hand, in the client device 6, the end-system multicast tree selecting means 207 selects that from which end-system multicast tree it receives segments required for playing back the content, using the transformation (3), and performs setting of the end-system multicast receiving means 201 (step C2 of FIG. 8B).

If the content is distributed in accordance with the distribution schedule in FIG. 1, for example, the end-system multicast tree selecting means 207 performs setting in such a manner that in a cycle 1, the end-system multicast receiving means 201 is set to participate in end-system multicast trees 1 to 3 so as to receive segments 1 to 3, and in a cycle 2, it is set to participate in end-system multicast trees 2 and 3 so as to receive segments 4 and 6. In the cycle 2, since it is not required to receive the segment 1 which has already been received in the cycle 1, the end-system multicast receiving means 201 is set not to participate in the end-system multicast tree 1.

The end-system multicast receiving means 201 participates in the end-system multicast trees in accordance with the selection of the end-system multicast tree selecting means 207, and receives only segments required for playing back the content (step A4 in FIG. 8B).

If there are client devices requesting playback of a content which requires to be relayed to each end-system multicast tree in which the end-system multicast receiving means participate (step A7 in FIG. 8B), the end-system multicast tree selecting means 207 selects, in accordance with the transformation (3), which end-system multicast tree is used to transmit a segment received by the end-system multicast receiving means 201, and performs setting of the end-system multicast transmission means 203 (step C3 in FIG. 8B).

In accordance with the selection of the end-system multicast tree selecting means 207, the end-system multicast transmission means 203 transmits the received segments (step A8 in FIG. 8B).

Note that in FIG. 2, the length of each segment differs, and the length of a cycle is different for each channel, as described above. If a content is transmitted in accordance with the distribution schedule in FIG. 2, the end-system multicast tree selecting means 105 performs setting of the end-system multicast transmission means 102 so as to use a different tree each time it transmits a segment over each of the channels 1 to 3 as same as the case of performing transmission in accordance with the distribution schedule shown in FIG. 1, in such a manner that a firstly transmitted segment 1 over the channel 1 uses a tree number “1” and a secondly transmitted segment 1 uses a tree number “4”, a firstly transmitted segment 2 over the channel 2 uses a tree number “2” and a secondly transmitted segment 2 uses a tree number “5”, and a firstly transmitted segment 3 over the channel 3 uses a tree number “3” and a secondly transmitted segment 3 uses a tree number “6”.

The fifth embodiment of the present invention is so configured to establish an end-system multicast tree by a channel unit and by a segment unit and performs distribution. Therefore, in addition to the effects of the first embodiment, the client devices 6 can receive only segments required for playing back by selecting a tree to participate in each cycle, as same as the case of the third embodiment. Accordingly, it is possible to avoid unnecessary data relay and to reduce the relay bandwidth of the client devices 6. Further, if an established end-system multicast tree is once used in the corresponding cycle, it will never be used again in the subsequent cycles. Therefore, the structure of the trees will never be changed drastically by rebuilding the tress due to playback requests from additional client devices during distribution of the content. Thus, the stability of the distribution trees can be improved.

1. A content distribution system comprising:
a distribution server device which holds a content and distributes the content according to a request; and
a plurality of client devices which request the distribution server device to play back the content; wherein
the distribution server device has a function of transmitting stream data, obtained by converting the content in accordance with an algorithm of near video on demand, to a multicast tree composed of the plurality of client devices, and
the client devices have a function of relaying the stream data received from the distribution server device to other client devices in accordance with the multicast tree to thereby transmit the stream data.

2. The content distribution system, as claimed in claim 1, wherein the distribution server device includes near-video-on-demand conversion means, which divides the content into a plurality of segments in accordance with an algorithm of the near video on demand, and repeatedly outputs divided segments using a plurality of channels.

3. The content distribution system, as claimed in claim 2, wherein the near-video-on-demand conversion means includes time-division multiplexing means, which time-division multiplexes the plurality of channels for outputting the content of the divided segments, and
transmission means of the distribution server device outputs the segments over a time-division multiplexed channel.

4. The content distribution system, as claimed in claim 1, wherein the near-video-on-demand conversion means includes selecting means, which selects a multicast tree for transmitting the stream data, and
transmission means of the distribution server device transmits the stream data in accordance with the multicast tree selected by the selecting means.

5. The content distribution system, as claimed in claim 4, wherein the selecting means selects a different multicast tree for each channel.

6. The content distribution system, as claimed in claim 4, wherein the selecting means selects a different multicast tree for each segment.

7. The content distribution system, as claimed in claim 4, wherein the selecting means selects a different multicast tree for each segment output to a plurality of channels.

8. The content distribution system, as claimed in claim 1, wherein receiving means of the client device participates in the multicast tree and receives only segments required for playing back the content.

9. A content distribution method, including a distribution server device which holds a content and distributes the content according to a request, and a plurality of client devices which request the distribution server device to play back the content, comprising the steps of:
transmitting stream data, obtained by converting the content in accordance with an algorithm of near video on demand, from the distribution server device to the client devices in accordance with a multicast tree composed of the plurality of client devices; and
relaying the stream data received by the client devices to other client devices in accordance with the multicast tree to thereby transmit the stream data.

10. The content distribution method, as claimed in claim 9, wherein as the stream data, stream data, obtained in such a manner that the content is divided into a plurality of segments in accordance with an algorithm of near video on demand and the segments are repeatedly output over a plurality of channels, is used.

11. The content distribution method, as claimed in claim 10, comprising, time-division multiplexing the plurality of channels, and outputting the segments over a time-division multiplexed channel.

12. The content distribution method, as claimed in claim 10, comprising, selecting a multicast tree for transmitting the stream data, and transmitting the stream data in accordance with a selected multicast tree.

13. The content distribution method, as claimed in claim 12, comprising, selecting a different multicast tree for each channel.

14. The content distribution method, as claimed in claim 12, comprising, selecting a different multicast tree for each segment.

15. The content distribution method, as claimed in claim 12, comprising, selecting a different multicast tree for each segment output to the plurality of channels.

16. The content distribution method, as claimed in claim 9, comprising, participating in the multicast tree, and receiving, by receiving means of the client devices, only segments required for playing back the content.

17. A distribution server device which distributes a content to be played back by a plurality of client devices according to requests from the plurality of client devices, wherein
the distribution server device is a distribution server device according to claim 1.

18. A client device for playing back a content distributed from a distribution server device, wherein
the client device is a client device according to claim 1.

19. A program for distributing a content, including a distribution server device which holds a content and distributes the content according to a request, and a plurality of client devices which request the distribution server device to play back the content, comprising:
a transmitting function for causing the distribution server device to execute a function of transmitting stream data, obtained by converting the content in accordance with an algorithm of near video on demand, in accordance with a multicast tree composed of the plurality of client devices; and
a relaying function for causing the client devices which receive the stream data to execute a function of relaying the stream data to other client devices in accordance with the multicast tree to thereby transmit the stream data.
